(19) United States
(12) Patent Application Publication
(10) Pub. No.: US 2007/0148514 A1
(43) Pub. Date: Jun. 28, 2007

(54) Fuel cells

(76) Inventors: Zhiping Jiang, Westford, MA (US); Javit A. Drake, Waltham, MA (US); Andrew G. Gilicinski, Danville, CA (US); Michael J. Zuraw, Bethel, CT (US); Robert Pavlinsky, Oxford, CT (US); John Perry Scartozzi, Clifton Park, NY (US); John Walczyk, Albany, NY (US); Anna Maria Bofinger, Nashua, NH (US)

Correspondence Address: FISH & RICHARDSON P.C., P.O. BOX 1022, MINNEAPOLIS, MN, 55440-1022, US

(21) Appl. No.: 11/318,374

(22) Filed: Dec. 22, 2005

(51) Int. Cl. H01M 8/10; H01M 2/02

(52) U.S. Cl. 429/30; 429/34

(57) ABSTRACT

Fuel cell systems, as well as related components and methods, are disclosed.

### TECHNICAL FIELD

The invention relates to fuel cell systems, and to related components and methods.

### BACKGROUND

A fuel cell is a device capable of providing electrical energy from an electrochemical reaction, typically between two or more reactants. Generally, a fuel cell includes two electrodes, called an anode and a cathode, and a solid electrolyte disposed between the electrodes. The anode contains an anode catalyst, and the cathode contains a cathode catalyst. The electrolyte, such as a membrane electrolyte, is typically ionically conducting but electronically non-conducting. The electrodes and solid electrolyte can be disposed between two gas diffusion layers (GDLs).

During operation of the fuel cell, the reactants are introduced to the appropriate electrodes. At the anode, the reactant(s) (the anode reactant(s)) interacts with the anode catalyst and forms reaction intermediates, such as ions and electrons. The ionic reaction intermediates can flow from the anode, through the electrolyte, and to the cathode. The electrons, however, flow from the anode to the cathode through an external load electrically connecting the anode and the cathode. As electrons flow through the external load, electrical energy is provided. At the cathode, the cathode catalyst interacts with the other reactant(s) (the cathode reactant(s)), the intermediates formed at the anode, and the electrons to complete the fuel cell reaction.

For example, in one type of fuel cell, sometimes called a direct methanol fuel cell (DMFC), the anode reactants include methanol and water, and the cathode reactant includes oxygen (e.g., from air). At the anode, methanol is oxidized; and at the cathode, oxygen is reduced:

CH₃OH+H₂O→CO₂+6H⁺+6e⁻ (1)

3/2O₂+6H⁺+6e⁻→3H₂O (2)

CH₃OH+3/2O₂→CO₂+2H₂O (3)

As shown in Equation (1), oxidation of methanol produces carbon dioxide, protons, and electrons. The protons flow from the anode, through the electrolyte, and to the cathode. The electrons flow from the anode to the cathode through an external load, thereby providing electrical energy. At the cathode, the protons and the electrons react with oxygen to form water (Equation 2). Equation 3 shows the overall fuel cell reaction.

### SUMMARY

The invention relates to fuel cell systems, and to related components and methods.

In one aspect, the invention features a cartridge with a housing including a first layer including a polymer and a second layer including a metal. The housing contains an alcohol fuel (e.g., methanol) or a hydrocarbon fuel.

In another aspect, the invention features a cartridge with a housing including a metallized polymer and/or a halogenated polymer. The housing contains an alcohol fuel or a hydrocarbon fuel.

In an additional aspect, the invention features a cartridge with a housing including a first polymer layer and a second polymer layer contacting the first polymer layer. The housing contains an alcohol fuel or a hydrocarbon fuel.

In a further aspect, the invention features a cartridge with a housing including a polymer and a glass, a ceramic, and/or carbon. The first housing contains an alcohol fuel or a hydrocarbon fuel.

Embodiments can include one or more of the following features.

The cartridge can include at least two housings. In some embodiments, one housing of the cartridge can be disposed within another housing of the cartridge. In certain embodiments, at least one housing of the cartridge can include a membrane vent.

The housing can have a thickness of at most 0.005 inch. The housing can include a layer having a thickness of at most about five mil (e.g., at most about four mil, at most about three mil, at most about two mil, at most about 1.5 mil, at most about one mil, at most about 0.5 mil). In some embodiments, the housing may not include a sealant.

The metal can be aluminum.

The polymer can be a plastic. The polymer can include polyethylene, polypropylene, or a combination thereof.

The housing can include a metallized and/or halogenated (e.g., fluorinated) polymer. The metallized polymer can include a polymer and a metal.

The polymer can have a methanol permeability coefficient of at most about 1.6×10⁻⁴ μg-cm/cm²-s and/or at least about zero μg-cm/cm²-s, and/or a gas (e.g., oxygen, nitrogen) permeability coefficient of at most about 5×10⁻¹⁵ cm³(STP)-cm/cm²-s-Pa and/or at least about zero cm³(STP)-cm/cm²-s-Pa (e.g., after a storage period of one month, and/or at a ratio of inner housing volume to inner housing surface area of 0.44 centimeter).

The housing can include a layer including a polymer and/or a metal (e.g., aluminum). The housing can include another layer that is supported by the layer including a polymer and/or a metal. The other layer can form a coating on the layer including a polymer and/or a metal.

The housing can include a first layer including a metal and a second layer including a polymer. The second layer can be laminated to the first layer and/or can be coextensive with the first layer. The second layer can contact the first layer. In some embodiments, the cartridge (e.g., a housing of the cartridge) can include a third layer. The third layer can include a polymer and/or a metal. The polymer and/or metal in the third layer can be the same as, or different from, the polymer in the second layer and/or the metal in the first layer.

In some embodiments, the polymer layers can be co-extruded. In certain embodiments, the polymer layers can be coextensive. In some embodiments, the polymer layers can be laminated to each other. At least one of the polymer layers can include polyvinylidene dichloride (PVDC), ethylene vinyl alcohol polymer (EVOH), polyvinylidene difluoride (PVDF), polyethylene (PE), polypropylene (PP), polyethylene terephthalate (PET), or a combination thereof.

The housing can include a layer including glass. The glass can include a silicon oxide and/or a boron oxide. In some embodiments, the ceramic can include an oxide, a carbide, and/or a nitride. In certain embodiments, the ceramic can include silicon, boron, aluminum, titanium, or a combination thereof.

Embodiments can include one or more of the following advantages.

The cartridge can be relatively safe to store, handle, and/or use. For example, the cartridge can include a housing that is substantially impermeable to a fuel contained in the housing. As a result, the cartridge can be unlikely to leak the fuel.

Fuel that is contained within the cartridge can be unlikely to become contaminated. For example, the cartridge can include a housing that is substantially impermeable to at least one gas (e.g., oxygen, nitrogen, air). By being substantially impermeable to at least one gas, the housing can limit or prevent this gas from entering the housing and contacting the fuel contained within the housing, thereby contaminating the fuel and/or causing bubbles to form in the fuel. Bubble formation in the fuel can interrupt the flow of fuel out of the cartridge, and/or can result in pressure elevation within the cartridge, which can cause the cartridge to burst and eject fuel. Furthermore, if gas enters the housing, then it can lower the efficiency of a fuel delivery mechanism (e.g., a pump) used to deliver fuel from the housing.

In certain embodiments, the cartridge can include at least one housing that is not sealed with a sealant. For example, the housing can be formed of a sealable (e.g., weldable) material. In some embodiments, the housing can be formed of two sheets of a sealable material that are sealed together. In certain embodiments, fuel that is contained within a housing that does not include a sealant can be relatively unlikely to become contaminated.

In some embodiments, the cartridge can include at least one housing having a relatively high mechanical strength. For example, the housing can have a relatively high yield strength, puncture resistance, and/or tear resistance. As a result, the housing can be fabricated, handled, and/or stored relatively easily (e.g., because the housing can be unlikely to become damaged during fabrication, handling, and/or storage).

In some embodiments, a cartridge housing can be formed of a material that is relatively unlikely to react with, and/or contaminate, fuel contained within the cartridge. Reaction between a cartridge housing material and a fuel can, for example, cause the mechanical stability of the housing to decrease (e.g., by causing the housing to swell).

In certain embodiments, the cartridge can include at least one housing (e.g., a bladder) that is formed of a relatively flexible and/or expandable material. This can, for example, allow the housing to expand to accommodate fuel, and/or to collapse as fuel is consumed. In some embodiments in which a pump is used to pump fuel from the cartridge, a collapsible inner housing can help the pump to operate relatively efficiently (e.g., by directing fuel toward the pump).

In certain embodiments, the cartridge can include at least one housing that is relatively thin. For example, the cartridge can include a housing having a thickness of less than 0.005 inch (e.g., when the cartridge has a volume of about 100 cubic centimeters). As the thickness of a cartridge housing decreases, the volume of fuel contained by the cartridge housing can increase. A cartridge that can contain a relatively high volume of fuel can be used, for example, in portable power applications (e.g., in cellular phones).

In some embodiments, at least one housing of the cartridge can be formed of one or more materials that are relatively abundant and/or easily procured. In certain embodiments, a cartridge housing can be manufactured relatively inexpensively and/or in relatively high volume.

In some embodiments, the cartridge can include a multilayer housing that is unlikely to experience the formation of air and/or fuel bubbles between its layers. Such air and/or fuel bubbles can, for example, cause the mechanical stability of a housing to decrease.

Other aspects, features, and advantages of the invention are in the drawings, description, and claims.

### DESCRIPTION OF DRAWINGS

FIG. 1 is a schematic diagram of an embodiment of a fuel cell system.

FIG. 2A is a side cross-sectional view of an embodiment of a fuel source.

FIG. 2B is a side view of a component of the fuel source of FIG. 2A.

FIG. 2C is a cross-sectional view of the component of FIG. 2B, taken along line 2C-2C.

FIG. 3 is a side cross-sectional view of an embodiment of a fuel source.

FIG. 4 is a side cross-sectional view of an embodiment of a fuel source.

FIG. 5 is a side cross-sectional view of an embodiment of a fuel source.

FIG. 6 is a side cross-sectional view of an embodiment of a fuel source.

FIG. 7 is a side cross-sectional view of an embodiment of a fuel source.

FIG. 8 is a side cross-sectional view of an embodiment of a fuel source.

FIG. 9 is a side cross-sectional view of an embodiment of a fuel source.

FIG. 10 is a side cross-sectional view of an embodiment of a fuel source.

### DETAILED DESCRIPTION

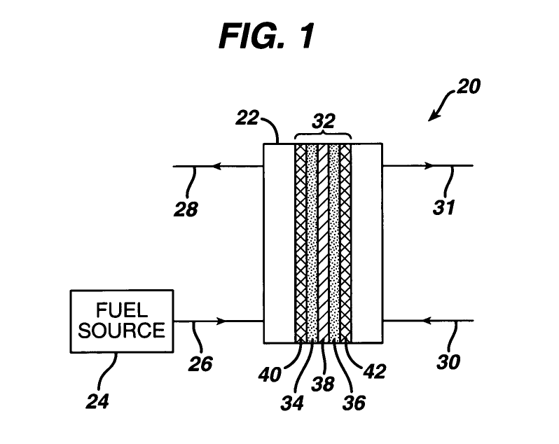

Referring to FIG. 1, a fuel cell system 20, such as a direct methanol fuel cell (DMFC) system, is shown. Fuel cell system 20 includes a fuel cell stack 22, a fuel source 24 (as shown, a cartridge) in fluid communication with the fuel cell stack via a fuel inlet 26, a fuel outlet 28, a cathode reactant (e.g., air) inlet 30 in fluid communication with the fuel cell stack, and a cathode reactant outlet 31. For clarity, fuel cell stack 22 is shown having one fuel cell 32 (described below), but in other embodiments, the fuel cell stack includes a plurality of fuel cells (e.g., arranged in series or in parallel). Briefly, fuel cell 32 includes an anode 34 in fluid communication with cartridge 24, a cathode 36, and an electrolyte 38 between the anode and the cathode. Fuel cell 32 further includes two gas diffusion layers (GDL) 40 and 42, one disposed on each side of the electrolyte 38, anode 34, and cathode 36 assembly.

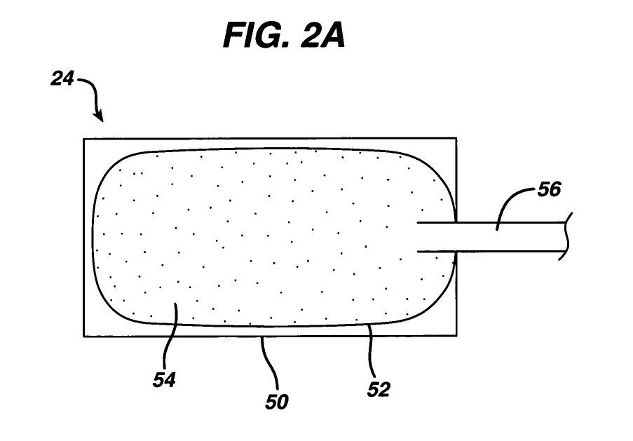

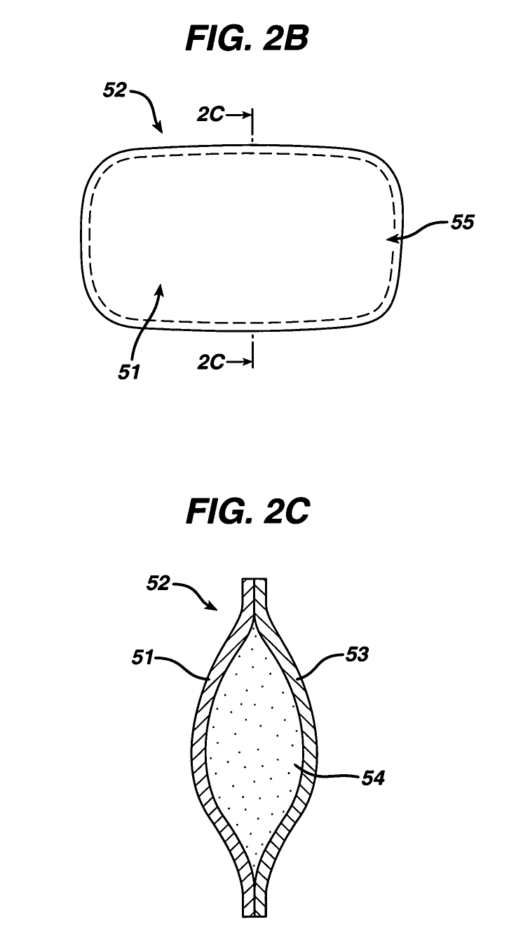

FIG. 2A shows a cross-sectional view of cartridge 24. As shown in FIG. 2A, cartridge 24 includes an outer housing 50 and an inner housing 52 within outer housing 50. A fuel inlet 56 extends through both outer housing 50 and inner housing 52, and is in fluid communication with fuel 54.

Referring also now to FIGS. 2B and 2C, inner housing 52 is formed of two sheets 51 and 53 of material that are sealed together. At one location 55, sheets 51 and 53 are not sealed together, in order to provide an opening for fuel inlet 56. Inner housing 52, which contains a fuel 54, can be relatively inflexible, or can be relatively flexible (e.g., inner housing 52 can be in the form of a flexible bladder). Inner housing 52 includes one or more layers, and is formed of one or more materials (e.g., one or more polymers, metals, and/or metal alloys). The materials of inner housing 52 can be selected based on one or more of the following characteristics.

In some embodiments, inner housing 52 can include one or more materials that are relatively compatible with fuel 54. For example, the materials can be relatively unlikely to chemically react with fuel 54, to swell upon contacting fuel 54, and/or to contaminate fuel 54. Examples of materials that are relatively compatible with methanol include stainless steel, aluminum, polymer-laminated aluminum, and certain polymers (e.g., polyethylene, polypropylene).

In some embodiments, inner housing 52 can include one or more materials that are substantially impermeable to fuel 54. A housing including one or more materials that are substantially impermeable to a fuel can, for example, experience little or no fuel loss (e.g., during storage). As used herein, a material that is substantially impermeable to a fuel can have a permeability coefficient for the fuel of at most about 1.6×10⁻⁴ μg-cm/cm²-s, and/or a permeation rate for the fuel of less than about 1.1×10⁻³ g/cm²-day at 30° C.

A fuel permeability coefficient (P_{F}) of a film of material can be determined by using the bladder (bag) procedure described in Example 1 below and calculating PF from the results of the procedure using the following equation:

$${P}_{F} = \frac{\begin{matrix}\text{(quantity of fuel that permeated through bladder)} \times \\ ( film thickness )\end{matrix}}{( area of bladder ) \times ( permeation time period )}$$

A fuel permeation rate (Q_{F}) of a film of material can be determined by using the bladder (bag) procedure described in Example 1 below and calculating Q_{F} from the results of the procedure using the following equation:

$${Q}_{F} = \frac{\text{(quantity of fuel that permeated through bladder)}}{( area of bladder ) \times ( permeation time period )}$$

Examples of materials that can be substantially impermeable to methanol include stainless steel, aluminum foil, and polymer-laminated aluminum.

Permeability coefficients and permeation rates (or transmission rates) are described, for example, in S. Pauly, “Permeability and Diffusion Data”, Polymer Handbook (4^{th} ed., John Wiley & Sons, Inc., 1999), pages 543-546.

In some embodiments, inner housing 52 can include one or more materials that are substantially impermeable to at least one gas (e.g., oxygen, nitrogen, air). This can, for example, limit or prevent the gas from entering inner housing 52 and contacting fuel 54. If gas enters housing 52, it may cause bubbles to form in fuel 54, thereby contaminating fuel 54 and/or complicating fuel delivery. In some cases, the gas may interfere with the operation of components of cartridge 52, such as a pump. As used herein, a material that is substantially impermeable to at least one gas (e.g., N₂) can have a permeability coefficient for that gas of at most about 5×10⁻¹⁵ cm³(STP)-cm/cm²-s-Pa, and/or a permeation rate for that gas of less than about 2.5×10⁻³ cc/cm²-day at 30° C. In certain embodiments, a material that is substantially impermeable to oxygen (O₂) can have an oxygen permeability coefficient of at most about 5×10⁻¹⁵ cm³(STP)-cm/cm²-s-Pa, and/or an oxygen permeation rate of less than about 6.25×10⁻⁴ cc/cm²-day at 30° C.

A gas permeability coefficient (P_{G}) of a film of material can be determined by using the bladder (bag) procedure described in Example 1 below and calculating P_{G} from the results of the procedure using the following equation (in which the “gas partial pressure drop across film” is the difference between the partial pressure of the gas outside of the bladder and the partial pressure of the gas within the bladder):

$${P}_{G} = \frac{\begin{matrix}\text{(quantity of gas that permeated through bladder)} \times \\ ( film thickness )\end{matrix}}{\begin{matrix}( area of bladder ) \times ( permeation time period ) \times \\ ( gas partial pressure drop across film )\end{matrix}}$$

A gas permeation rate (Q_{G}) of a film of material can be determined by using the bladder (bag) procedure described in Example 1 below and calculating Q_{G} from the results of the procedure using the following equation:

$${Q}_{G} = \frac{\text{(quantity of gas that permeated through bladder)}}{( area of bladder ) \times ( permeation time period )}$$

Examples of materials that can be substantially impermeable to one or more gases (e.g., relatively non-corrosive gases, such as air, CO₂, N₂, O₂, Ar, H₂, and/or He) include stainless steel, aluminum foil, and polymer-laminated aluminum.

In some embodiments, inner housing 52 can include one or more materials that are substantially impermeable to water. This can, for example, limit the likelihood of water entering housing 52 and diluting and/or contaminating fuel 54. As used herein, a material that is substantially impermeable to water can have a water permeation rate of less than about one μg/cm²-day.

The water permeation rate (Q_{W}) of a film of material can be measured by forming a bladder out of the material, filling the bladder with fuel (e.g., methanol), immersing the bladder in water for 24 hours, opening the bladder, and then measuring the amount of water inside of the bladder (e.g., using Karl Fisher titration). This measurement can then be used to calculate Q_{W} using the equation below:

$${Q}_{W} = \frac{( quantity of water within bladder )}{( area of bladder ) \times ( permeation time period )}$$

Examples of materials that can be substantially impermeable to water include stainless steel, aluminum foil, and polymer-laminated aluminum.

In some embodiments, inner housing 52 can include one or more materials that are relatively mechanically stable. A material that is relatively mechanically stable can, for example, maintain its barrier properties (e.g., low fuel, air, and/or water permeability) at an elevated temperature over an extended period of time. In certain embodiments, a material that is relatively mechanically stable can experience little or no corrosion, brittleness, and/or delamination when maintained at a temperature of 60° C. for two months.

In some embodiments, a relatively mechanically stable material can have a tensile strength of at least about one MPa. As used herein, the tensile strength of a material can be measured by placing a strip of the material between mechanical clamps, and pulling on the material until the material elongates non-elastically. In other words, the force vs. elongation is measured until the force decreases (indicating irreversible stretching, and ultimately severage, of the material). This test can be conducted using, for example, the Instron® Model 4202 (from Instron®, Norwood, Mass.). In some embodiments, the tensile test can be conducted on thermally joined strips of the material to verify the strength of the seal. In certain embodiments, the seal can have a strength of at least about one MPa. In some embodiments, a relatively mechanically stable material can have a puncture resistance of at least about 0.1 kilogram. As used herein, the puncture resistance of a material can be measured by clamping a sheet of the material and pressing the sheet with a metal probe having a diameter of about one millimeter, using increasing force (converted to a mass) until puncture occurs. This test can be conducted using, for example, an instrument (e.g., MTS Synergie 200) from MTS Systems Corporation (Eden Prairie, Minn.). Examples of materials that can be relatively mechanically strong include aluminum, stainless steel, and polymer-laminated aluminum.

In some embodiments, inner housing 52 can be relatively flexible. For example, inner housing 52 can include (e.g., can be formed of) one or more relatively flexible materials. As the flexibility of inner housing 52 increases, the efficiency of fuel delivery from cartridge 24, and/or the utilization of fuel 54, can increase.

In certain embodiments in which inner housing 52 is formed of one or more relatively flexible materials, the relatively flexible materials can give inner housing 52 the ability to collapse without excessive suction. In some embodiments, inner housing 52 can be sufficiently flexible to allow for at least 95 percent of fuel 54 to be extractable from inner housing 52 using a suction pressure of five psi or less. In certain embodiments, inner housing 52 can be sufficiently flexible to allow for about 100 percent of fuel 54 to be extractable from inner housing 52 using a suction pressure of zero psi.

In some embodiments, a relatively flexible material can have a relatively low flexural modulus. As used herein, the flexural modulus of a material can be measured using a “bend” testing apparatus (e.g., a Universal Electromechanical Testing System from Instron (Norwood, Mass.)). Typically, as the flexural modulus of one or more of the materials of inner housing 52 decreases, the flexibility of inner housing 52 can increase. Examples of materials that can be relatively flexible include polymer-laminated aluminum foil and certain polymers, such as polyolefins, polyesters, nylon, polyethylene-co-polyvinyl alcohol, polyvinylidene dichloride, and Teflon®.

In certain embodiments, inner housing 52 can include one or more materials that can allow sheets 51 and 53 to be relatively easily sealed together. For example, in some embodiments, sheets 51 and 53 can be thermally sealed together (e.g., by heating sheets 51 and 53 to about 150° C. using a heating element). In certain embodiments, sheets 51 and 53 can be sealed together by welding. In some embodiments, sheets 51 and 53 can be sealed with little or no sealant. As the amount of sealant used to seal sheets 51 and 53 decreases, the amount of fuel 54 contained in inner housing 52 can increase, and/or the likelihood of contamination of fuel 54 can decrease. Examples of materials that can be relatively easily sealed (e.g., without using sealant) include stainless steel, aluminum, polymer-laminated aluminum, silicone, and certain polymers, such as ethylene propylene rubber (EPDM), Neoprene polychloroprene (from DuPont), and polytetrafluoroethylene (PTFE) (Teflon®, from DuPont).

In certain embodiments, inner housing 52 can include one or more materials that can allow inner housing 52 to be relatively thin. For example, inner housing 52 can include one or more thermoplastic (extrudable) polymers, one or more metals that are capable of being heat-rolled and/or electrochemically plated, and/or one or more metals that are capable of being deposited by physical vapor deposition and/or sputtering. In some embodiments, inner housing 52 can have a thickness of less than 0.005 inch (e.g., less than 0.004 inch, about 0.003 inch). As the thickness of inner housing 52 decreases, the amount of space occupied by cartridge 24 can decrease, and/or the amount of fuel 54 contained by cartridge 24 can increase. Examples of materials that can be used in a relatively thin inner housing 52 include stainless steel, aluminum, polymer-laminated aluminum, and certain single- or multi-layered polymers (e.g., polypropylene, polyethylene, polyesters, nylon, polyvinylidene dichloride, polyethylene-co-polyvinyl alcohol).

While a relatively thin inner housing 52 has been described, in some embodiments, inner housing 52 can be relatively thick. For example, inner housing 52 can have a thickness of at least about 0.01 inch (e.g., at least about 0.02 inch). As the thickness of inner housing 52 increases, the abrasion resistance of housing 52, and/or the air, humidity, and/or carbon dioxide permeability of inner housing 52, can decrease.

In some embodiments, inner housing 52 can include one or more relatively inexpensive materials, such as aluminum, polymer-laminated aluminum, and certain polymers (e.g., polyethylene, polypropylene). Other examples of relatively inexpensive materials that can be used in inner housing 52 include laminated polymer films, such as PE/PVDC/PE, PET/PE/EVOH/PE, and PET/PE. This can, for example, allow inner housing 52 to be manufactured at a relatively high volume and for a relatively low cost.

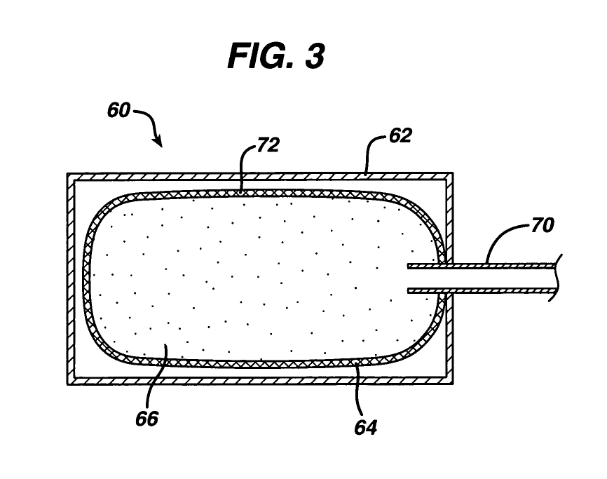

FIGS. 3-9 show exemplary fuel sources including housings formed of materials having one or more of the above-described characteristics.

For example, FIG. 3 shows a cartridge 60 including an outer housing 62 and an inner housing 64 within outer housing 62. Inner housing 64 contains a fuel 66. A fuel inlet 70 extends through both outer housing 62 and inner housing 64, and is in fluid communication with fuel 66.

Inner housing 64 is formed of a halogenated polymer film 72. Halogenated polymer film 72 can be relatively impermeable to air and/or organic compounds (e.g., organic fuels). In some embodiments, halogenated polymer film 72 can be formed by treating the surface of a polymer film with a halogen or a halogen compound, such as a fluorine compound. Halogens include fluorine, chlorine, bromine, iodine, and astatine. Examples of polymers that can be used to form halogenated (e.g., fluorinated) polymer films include polyethylene (e.g., high-density polyethylene) and polypropylene.

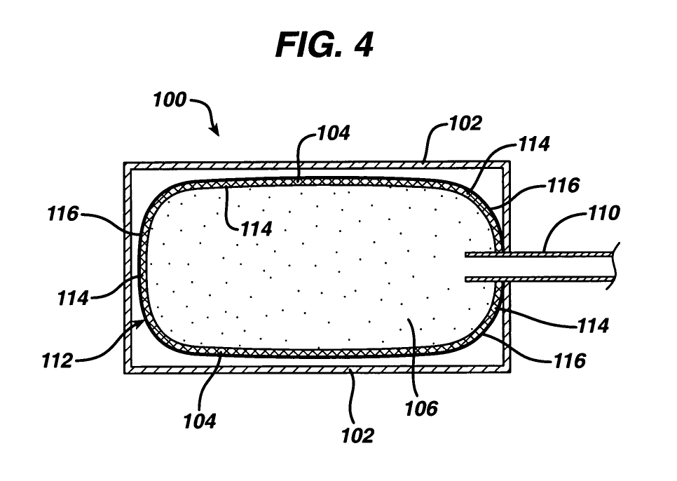

FIG. 4 shows a cartridge 100 including an outer housing 102 and an inner housing 104 within outer housing 102. Inner housing 104 contains a fuel 106 (e.g., methanol). A fuel inlet 110 extends through both outer housing 102 and inner housing 104, and is in fluid communication with fuel 106.

Inner housing 104 is formed of a metallized polymer film 112 that includes an inner polymer layer 114 and an outer metal layer 116. Metallized polymer film 112 can, for example, be both relatively chemically stable and substantially impermeable to air and/or to fuel 106.

In some embodiments, metallized polymer film 112 can be formed by depositing one or more metals onto polymer layer 118. Metals can be deposited onto polymer layer 118 using, for example, an evaporation method and/or a sputtering method, such as sputtering conducted under vacuum. As an example, in certain embodiments, a physical vaporization method can be used. The physical vaporization method can include subliming or evaporating a metal (e.g., aluminum) into the gas phase via high temperature (e.g., at least about 800° C.) and/or low pressure (e.g., at most 0.01 psi), and subsequently depositing the metal onto polymer layer 118 to eventually form metal layer 116. As another example, in some embodiments, a sputtering method can be used. The sputtering method can include ejecting atoms from a metal by impacting the metal with high kinetic energy atoms and/or ions. The metal atoms can be deposited onto polymer layer 118, eventually forming metal layer 116.

In certain embodiments, metallized polymer film 112 can be formed using a thin-film vapor deposition method.

Polymer layer 114 includes one or more polymers. The polymers can be selected, for example, to be relatively stable (e.g., to have little or no reaction with fuel 106). Examples of polymers that can be relatively stable in the presence of a fuel (e.g., methanol) include polyolefins, such as polyethylene and polypropylene.

Metal layer 116 includes one or more metals and/or metal alloys. The metals and/or metal alloys can be selected, for example, to be substantially impermeable to air and/or to fuel 106. Examples of metals that can be substantially impermeable to air and/or fuel include aluminum, nickel, gold, platinum, and silver. Examples of metal alloys that can be substantially impermeable to air and/or fuel include stainless steel, brass, and nickel-chrome.

While metallized polymer film 112 is shown as including an inner polymer layer 114 and an outer metal layer 116, in some embodiments, a metallized polymer film can include an inner metal layer and an outer polymer layer. In certain embodiments, a metallized polymer film can include a polymer layer in which one or more metals are partially and/or wholly embedded.

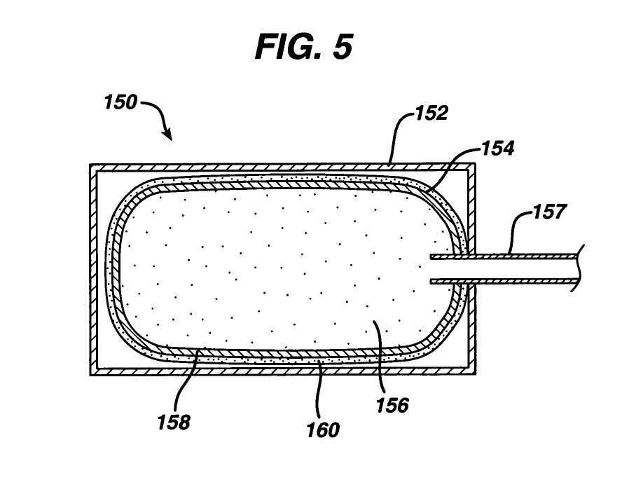

FIG. 5 shows a cartridge 150 including an outer housing 152 and an inner housing 154 within outer housing 152. Inner housing 154 contains a fuel 156 (e.g., methanol). A fuel inlet 157 extends through both outer housing 152 and inner housing 154, and is in fluid communication with fuel 156.

Inner housing 154 is formed of a metal layer 160 and a polymer layer 158 that is laminated to metal layer 160. For example, inner housing 154 can be formed of a laminated aluminum foil. In some embodiments, the lamination of polymer layer 158 to metal layer 160 can enhance the mechanical stability of metal layer 160, and/or can make it easier to seal inner housing 154. As an example, in certain embodiments, inner housing 154 can be formed of two sheets of polymer-laminated metal. The polymer layers in the sheets may seal to each other relatively easily (e.g., at a relatively low temperature), and/or may form a relatively strong seal with each other.

Metal layer 160 includes one or more metals. The metals can be selected, for example, to be substantially impermeable to air and/or to fuel 156. Examples of metals include aluminum, nickel, gold, silver, and platinum. In some embodiments, metal layer 160 can be formed of aluminum foil.

In certain embodiments, metal layer 160 can be relatively thin. For example, metal layer 160 can have a thickness of at least 10⁻⁶ inch and/or at most 0.005 inch. In some embodiments, metal layer 160 can have a thickness of less than 0.5 mil. In certain embodiments, the thickness of metal layer 160 can be less than the thickness of polymer layer 158.

Polymer layer 158 includes one or more polymers. The polymers can be selected, for example, for their chemical stability (e.g., the polymers can be selected to have little or no reaction with fuel 156). Examples of polymers include polyolefins, such as polyethylene (e.g., low-density polyethylene, high-density polyethylene, linear low-density polyethylene), and polypropylene. In some embodiments, polymer layer 158 can have a thickness of at least about 0.1 mil (e.g., at least about one mil, at least about three mil) and/or at most about five mil (e.g., at most about three mil, at most about one mil).

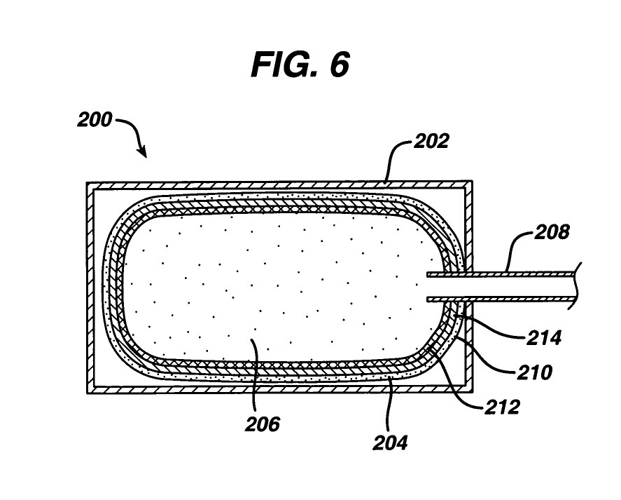

While housings with one metal layer and one polymer layer have been described, in some embodiments, a cartridge housing can further include one or more additional layers. For example, FIG. 6 shows a cartridge 200 including an outer housing 202 and an inner housing 204 within outer housing 202. Inner housing 204 contains a fuel 206 (e.g., methanol). A fuel inlet 208 extends through both outer housing 202 and inner housing 204, and is in fluid communication with fuel 206.

Inner housing 204 is formed of three layers: two polymer layers 210 and 212, and a metal layer 214 between polymer layers 210 and 212. In some embodiments, polymer layers 210 and 212 can be laminated to metal layer 214. Polymer layers 210 and 212 include one or more polymer materials, such as the polymer materials described above with respect to cartridge 150. In certain embodiments, a polymer layer (e.g., polymer layer 210, which is the outer layer of inner housing 204) can include one or more of the following polymers: nylon, polyesters, polyvinylidene chloride, polyvinylidene difluoride (PVDF), and ethylene vinyl alcohol polymer. Metal layer 214 includes one or more metals, such as the metals described above with respect to cartridge 150.

While multilayer housings with at least one metal layer and at least one polymer layer have been described, in some embodiments, a cartridge can include a multilayer housing formed of different combinations of materials.

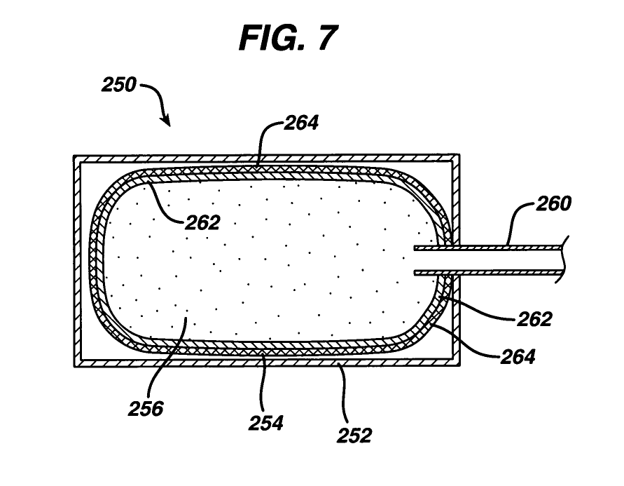

For example, FIG. 7 shows a cartridge 250 including an outer housing 252 and an inner housing 254 within outer housing 252. Inner housing 254 contains a fuel 256 (e.g., methanol). A fuel inlet 260 extends through both outer housing 252 and inner housing 254, and is in fluid communication with fuel 256.

Inner housing 254 is formed of two polymer layers 262 and 264. Polymer layer 262, which contacts fuel 256, can be selected to be relatively compatible with fuel 256. Examples of polymers that are relatively compatible with methanol include polyolefins (e.g., polypropylene, polyethylene) and copolymers thereof. Polymer layer 264 can be substantially impermeable to fuel 256, and/or to air. Examples of polymers that are substantially impermeable to methanol include polyvinylidene chloride, ethylene vinyl alcohol polymer, polyesters, and nylon. Examples of polymers that are substantially impermeable to air include polyvinylidene chloride, polyvinylidene difluoride (PVDF), ethylene vinyl alcohol polymer, polyesters, and nylon.

In some embodiments, inner housing 254 can be formed by extruding (e.g., coextruding) polymer layers 262 and 264. In certain embodiments, inner housing 254 can be formed by laminating polymer layers 262 and 264 to each other.

While inner housing 254 is formed of two polymer layers 262 and 264, in some embodiments, a housing can include more than two (e.g., three, four, five, six, seven, eight, nine, 10, 15, 20, 25, 50) polymer layers. As an example, in some embodiments, a housing can be formed of a three-layer polymer film including polyethylene interior and exterior layers, and a cyclic olefin copolymer layer between the interior and exterior layers. Cyclic olefin copolymers are available, for example, from Ticona Engineering Polymers (Florence, Ky.).

In certain embodiments, a housing can include one or more polymer layers and one or more tie layers. The tie layers can be formed, for example, of one or more adhesive polymers. As an example, in some embodiments, a housing can be formed of DOW BLF 2015 Backing Layer Film (from Dow Chemical), a multilayer material including polyethylene (PE), polyvinylidene chloride (PVDC), and tie layers (Tie) having the following configuration: PE/Tie/PVDC/Tie/PE. DOW BLF 2015 Backing Layer Film can be substantially impermeable to methanol and/or air, and/or can be relatively flexible. As another example, in some embodiments, a housing can be formed of SARANEX™ 14 coextruded barrier film (from Dow Chemical), a multilayer polymer film including PE, PVDC, and tie layers in the following configuration: PE/Tie/PVDC/Tie/PE. The SARANEX™ 14 coextruded barrier film has an overall thickness of about 2.0 mil.

In certain embodiments, an inner housing of a fuel source can include one or more substantially fuel-impermeable and/or air-impermeable layers sandwiched between at least two relatively fuel-permeable and/or air-permeable layers.

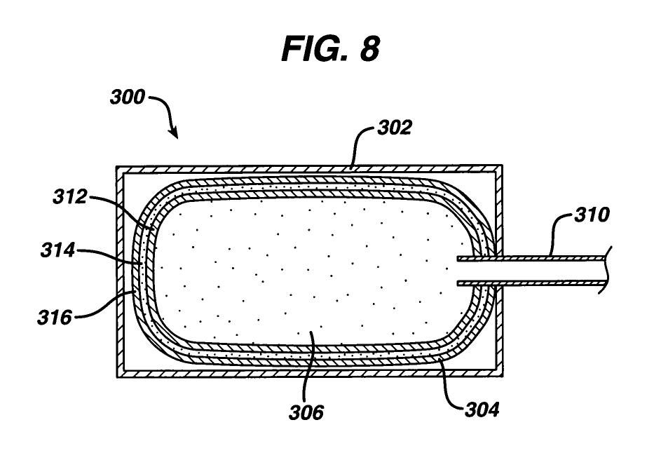

For example, FIG. 8 shows a cartridge 300 including an outer housing 302 and an inner housing 304 within outer housing 302. Inner housing 304 contains a fuel 306 (e.g., methanol). A fuel inlet 310 extends through both outer housing 302 and inner housing 304, and is in fluid communication with fuel 306.

Inner housing 304 is formed of an inner layer 312, an intermediate layer 314, and an outer layer 316. In some embodiments, inner housing 304 can be formed by extruding (e.g., coextruding) inner layer 312, intermediate layer 314, and/or outer layer 316. In certain embodiments, inner housing 304 can be formed by laminating inner layer 312 intermediate layer 314, and/or outer layer 316 to each other.

Inner layer 312, intermediate layer 314, and/or outer layer 316 can include one or more polymers, such as one or more of the polymers described above with reference to inner housing 254.

In some embodiments, inner layer 312 and/or outer layer 316 can be formed of one or more materials that are relatively permeable to fuel 306 and/or to air. In certain embodiments, inner layer 312 and/or outer layer 316 can be formed of one or more materials that are relatively chemically stable in the presence of fuel 306. Examples of materials that can be relatively permeable to methanol and to air, and that can be relatively stable in the presence of methanol, include polypropylene and polyethylene.

In certain embodiments, intermediate layer 314 can be formed of one or more materials that are substantially impermeable to one or more fuels, and/or that are substantially impermeable to air. In some embodiments, intermediate layer 314 can be formed of one or more metals.

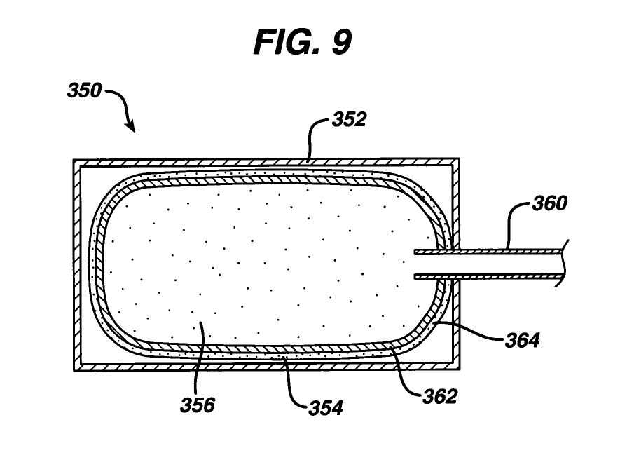

In some embodiments, an inner housing of a fuel source can include one or more glasses and/or ceramics. For example, FIG. 9 shows a cartridge 350 including an outer housing 352 and an inner housing 354 within outer housing 352. Inner housing 354 contains a fuel 356 (e.g., methanol). A fuel inlet 360 extends through both outer housing 352 and inner housing 354, and is in fluid communication with fuel 356.

Inner housing 354 includes an inner layer 362 and an outer layer 364. Inner layer 362 can be formed of, for example, a polymer film, such as a polymer film that is relatively chemically stable in the presence of methanol (e.g., polypropylene, polyethylene). Outer layer 364 can include one or more ceramics and/or glasses. The ceramics and/or glasses may cause outer layer 364 to be substantially impermeable to air and/or methanol. In some embodiments, outer layer 364 can include one or more oxides, carbides, and/or nitrides (e.g., of boron, silicon, aluminum, and/or titanium). In certain embodiments, outer layer 364 can include a silica oxide. In some embodiments, outer layer 364 can include carbon.

Inner housing 354 can be formed, for example, by depositing, coating, and/or laminating outer layer 364 onto inner layer 362. In some embodiments, inner housing 354 can be formed using a chemical vapor deposition method.

An outer housing of a fuel source, such as outer housing 50 (FIG. 2) can be formed of, for example, one or more metals (e.g., aluminum, nickel, gold, silver, platinum), metal alloys (e.g., stainless steel, brass, nickel-chrome), and/or polymers.

A fuel source (e.g., cartridge 24) can provide a vapor phase fuel or a liquid fuel to a fuel cell or fuel cell stack.

In some embodiments, a fuel source can include a fuel that is in a non-gaseous form (e.g., a liquid, a gel) and that has a vapor pressure sufficient to provide a vapor phase fuel to a fuel cell or fuel cell stack. A liquid fuel can include, for example, pure methanol, or a solution including methanol and water and/or gelling agent as non-fuel components. A fuel gel is a viscous material (e.g., from about 0.05 centipoises to about 200,000 centipoises) capable of emitting a pure and high concentration of vapor-phase fuel molecules. The viscosity can be, for example, at least about 10,000 centipoises (e.g., at least about 25,000 centipoises, at least about 50,000 centipoises, at least about 100,000 centipoises, at least about 150,000 centipoises), and/or at most about 200,000 centipoises (e.g., at most about 150,000 centipoises, at most about 100,000 centipoises, at most about 50,000 centipoises, at most about 25,000 centipoises). An example of a fuel gel composition includes a fuel (e.g., methanol), a diluent (e.g., deionized water), a thickener (e.g., hydroxypropyl cellulose thickener, Carbopol EZ-3 (an acidic, hydrophobically-modified, cross-linked polyacrylate powder)), and a neutralizing agent (e.g., tri-isopropanolamine). Other fuel gels are described in literature from Noveon that describe examples of the use of Carbopol rheology modifiers (manufactured by BF Goodrich), and are exemplified by cooking fuels (e.g., available from Sterno, and formulation examples listed by Noveon).

In certain embodiments, a fuel source can include a liquid fuel that is converted into a vapor phase fuel by being passed through a pervaporation membrane or a membrane delivery film. The resulting fuel vapor can then travel to a fuel cell (e.g., in a fuel cell stack). Pervaporation membranes are described, for example, in Bofinger et al., U.S. patent application Ser. No. 11/137,848, filed on May 25, 2005, and entitled “Fuel Cells”.

In some embodiments, a fuel source can include a rigid fuel composition that is capable of delivering a vapor phase fuel (e.g., methanol vapor) to a fuel cell or fuel cell stack. The fuel composition can be prepared from a liquid precursor composition that includes a fuel (e.g., methanol), a polymerizable material (e.g., an inorganic polymer, an organic polymer, or a hybrid thereof), and one or more catalysts (e.g., a dilute acid solution such as 0.10N H₂SO₄; a dilute base solution, such as 0.10N KOH; HCl; HNO₃; an organic acid; an organic amine). The liquid precursor composition can be rigidified, for example, by heat curing the composition to form a rigid polymeric network in which methanol is trapped in interstices defined by the polymeric network. In certain embodiments, a fuel source can include a rigid fuel composition that includes a fuel (e.g., methanol) rigidified in a cross-linked silica network.

In some embodiments, a fuel can further include additives, such as ethanol, ethylene glycol, and/or formic acid. In certain embodiments, a fuel can include fuel safety additives, such as colorants. Colorants are described, for example, in Bofinger et al, U.S. patent application Ser. No. 11/137,848, filed on May 25, 2005, and entitled “Fuel Cells”.

As noted above, in certain embodiments, a fuel source can provide a liquid fuel to a fuel cell or fuel cell stack. The liquid fuel can travel from the fuel source through a fuel inlet, entering the fuel cell or fuel cell stack and eventually directly contacting a fuel cell anode. In some embodiments, the liquid fuel can pass through one or more filters prior to contacting the anode. The filter may be, for example, a cellulosic filter and/or a molecular sieve. In certain embodiments, the filter can include activated charcoal.

A fuel source such as cartridge 24 (FIG. 1) can contain one or more fuels. Examples of fuels include alcohols (e.g., methanol, ethanol, isopropanol), ethylene glycol, formic acid, and other oxidizable hydrocarbons. Another example of a fuel is a lithium borohydride-based fuel. In certain embodiments, a fuel source can include neat (99.5 percent) methanol. As noted above, in some embodiments, a fuel source can include a fuel mixed with water. For example, a fuel source can include methanol and water. The methanol can be, for example, from about 85 percent by weight to about 95 percent by weight (e.g., about 90 percent by weight) of the mixture. In some embodiments, a fuel source can include more than one type of fuel. For example, a fuel source can include a mixture of methanol and ethanol. Fuel sources and fuels are described, for example, in Jiang et al., U.S. patent application Ser. No. 10/933,735, filed on Sep. 3, 2004, and entitled “Fuel Compositions”; Drake et al., U.S. patent application Ser. No. 10/957,935, filed on Oct. 4, 2004, and entitled “Fuel Sources, Fuel Cells and Methods of Operating Fuel Cells”; and Bofinger et al., U.S. patent application Ser. No. 11/137,848, filed on May 25, 2005, and entitled “Fuel Cells”.

Referring back to FIG. 1, an example of fuel cell 32 will now be described. Fuel cell 32 includes electrolyte 38, anode 34 bonded on a first side of the electrolyte, and cathode 36 bonded on a second side of the electrolyte. Electrolyte 38, anode 34, and cathode 36 are disposed between gas diffusion layers (GDLs) 40 and 42.

Electrolyte 38 should be capable of allowing ions to flow therethrough while providing a substantial resistance to the flow of electrons. In some embodiments, electrolyte 38 is a solid polymer (e.g., a solid polymer ion exchange membrane), such as a solid polymer proton exchange membrane (e.g., a solid polymer containing sulfonic acid groups). Such membranes are commercially available from E.I. DuPont de Nemours Company (Wilmington, Del.) under the trademark NAFION. Alternatively, electrolyte 38 can also be prepared from the commercial product GORE-SELECT, available from W.L. Gore & Associates (Elkton, Md.).

Anode 34 can be formed of a material, such as a catalyst, capable of interacting with methanol and water to form carbon dioxide, protons and electrons. Examples of such materials include, for example, platinum, platinum alloys (such as Pt—Ru, Pt—Mo, Pt—W, or Pt—Sn), platinum dispersed on carbon black. Anode 34 can further include an electrolyte, such as an ionomeric material (e.g., NAFION) that allows the anode to conduct protons. Alternatively, a suspension is applied to the surfaces of gas diffusion layers (described below) that face solid electrolyte 38, and the suspension is then dried. The method of preparing anode 34 may further include the use of pressure and temperature to achieve bonding.

Cathode 36 can be formed of a material, such as a catalyst, capable of interacting with oxygen, electrons and protons to form water. Examples of such materials include, for example, platinum, platinum alloys (such as Pt—Co, Pt—Cr, or Pt—Fe) and noble metals dispersed on carbon black. Cathode 36 can further include an electrolyte, such as an ionomeric material (e.g., NAFION) that allows the cathode to conduct protons. Cathode 36 can be prepared as described above with respect to anode 34.

Gas diffusion layers (GDLs) 40 and 42 can be formed of a material that is both gas and liquid permeable. Examples of GDLs are available from various companies such as Etek in Natick, Mass., SGL in Valencia, Calif., and Zoltek in St. Louis, Mo. GDLs 40 and 42 can be electrically conductive so that electrons can flow from anode 34 to an anode flow field plate (not shown) and from a cathode flow field plate (not shown) to cathode 36.

Other embodiments of direct methanol fuel cells and fuel cell systems, including methods of use, are described, for example, in Gilicinski et al., U.S. Patent Application Publication No. US 2005/0181258 A1, published on Aug. 18, 2005; J. Laraminie and A. Dicks, “Fuel Cell Systems Explained” (Wiley, N.Y., 2000); Lamy et al., “Direct Methanol Fuel Cells: From a Twentieth Century Electrochemist's Dream to a Twenty-first Century Emerging Technology”, Modern Aspects of Electrochemistry, No. 34, edited by J. Bockris et al. (Kluwer Academic/Plenum Publishers, New York (2001)) pp. 53-118; and Narayanan et al., “Development of a Miniature Fuel Cell for Portable Applications”, in Direct Methanol Fuel Cells, edited by Narayanan et al., Electrochemical Society Proceedings, 2001-4 (2001) Pennington, N.J.

During operation of fuel cell system 20, fuel from cartridge 24 is introduced to anode 34, a cathode reactant (such as air) is introduced to cathode 36, and electrical energy is produced from the respective oxidation and reduction reactions as described above. Excess fuel and cathode reactant exit through outlets 28 and 31, respectively.

### EXAMPLES

The following examples are illustrative and are not intended to be limiting.

### Example 1

Bladders (bags) were formed and tested for permeability according to the following procedures.

Bags with dimensions of about four inches by five inches were fabricated from different types of materials. For each bag, one side was open, and the other three sides were sealed. The three sealed sides were sealed using a polymer sealer and a sealing temperature of about 150° C. Bags #1-7 and #10-12 were sealed using a Model 14A/A3/8 Thermal Impulse foot-activated beat sealer from Vertrod (San Rafael, Calif.), and Bags #8 and #9 were sealed using a Model T 960 sealer from Janesville Tool and Manufacturing, Inc. (Milton, Wis.).

Bags #1 and #11 were formed of SARANEX™ 15 coextruded barrier film (from Dow Chemical), which is a multilayer film including polyethylene (PE) and polyvinylidene chloride (PVDC) in the following arrangement: PE/Tie/PVDC/Tie/PE, in which (Tie) indicates a tie layer. The SARANEX™ 15 coextruded barrier film that was used had an overall thickness of about 3.0 mil. When formed, Bags #1 and #11 had an outer PE layer that was in contact with the air, 13 intermediate PE layers, an intermediate PVDC layer, and an inner PE layer that was in contact with the contents of Bags #1 and #11 (such as methanol, once methanol was added into Bags #1 and #11 as described below).

Bags #2 and #12 were formed of a multilayer ethylene vinyl alcohol copolymer (EVOH) film (from Coextruded Plastic Technologies, Inc., Edgerton, Wis.). The film was a four-layer film including polyethylene terephthalate (PET), PE, and EVOH in the following arrangement: PET/PE/EVOH/PE. When formed, Bags #2 and #12 had an outer PET layer that was in contact with the air, an intermediate PE layer, an intermediate EVOH layer, and an inner PE layer that was in contact with the contents of Bags #2 and #12 (such as methanol, once methanol was added into Bags #2 and #12, as described below).

Bags #3 and #8 were formed of Flex-Seal MIL-B-117E, a polymer-laminated aluminum foil (from Flex-Seal, Barnsley, United Kingdom) that included PE layers and aluminum (Al) in the following arrangement: PE/Al/PE/PE. When formed, Bags #3 and #8 had an outer PE layer that was in contact with the air, an intermediate Al layer, an intermediate PE layer, and an inner PE layer that was in contact with the contents of Bags #3 and #8 (such as methanol, once methanol was added into Bags #3 and #8, as described below).

Bags #4 and #9 were formed of TL-435 multilayer film from Technipaq Inc. (Crystal Lake, Ill.). The film was a three-layer film including PET, aluminum (Al), and PE layers in the following arrangement: PET/AI/PE. When formed, Bags #4 and #9 had an outer PET layer that was in contact with the air, an intermediate Al layer, and an inner PE layer that was in contact with the contents of Bags #4 and #9 (such as methanol, once methanol was added into Bags #4 and #9, as described below).

Bags #5 and #10 were formed of CADPAK PL Series, MIL-PRF-131-J multilayer film from Cadillac Products Packaging Co. (Troy, Mich.). The film was a four-layer film including polypropylene (PP), PE, and Al layers in the following arrangement: PP/PE/Al/PE. When formed, Bags #5 and #10 had an outer PP layer that was in contact with the air, an intermediate PE layer, an intermediate Al layer, and an inner PE layer that was in contact with the contents of Bags #5 and #10 (such as methanol, once methanol was added into Bags #5 and #10, as described below).

Bag #6 was formed of Oxyshield® OEB co-extruded three-layer film from Honeywell. The film included Nylon 6 and EVOH in the following arrangement: (Nylon 6)/EVOH/(Nylon 6).

Bag #7 was formed of CAPRAN® EMBLEM™ MT2500 film, which is a two-layer metallized nylon film from Honeywell. The film included a Nylon 6 layer coated with a metallized aluminum outer barrier coating.

About 15 grams of methanol (OPTIMA methanol, from Fisher Scientific, assayed to ≧29.9% purity) were added into each bag to fill the bag, and the opening of each bag was then sealed using one of the polymer sealers.

Each bag was then weighed using a balance.

After being weighed, each bag was then immersed in water, and the weight of each bag was then measured.

Each bag was then stored in an oven at either 60° C. (Table 1 below) or 30° C. (Table 2 below). The weight of each bag in air and water was then periodically measured (typically weekly).

The permeation rate (g/cm²-day) of methanol through each bag was determined by measuring the difference of the weight of the bag before and after storage in the oven, over a given period of time.

For each bag, the permeation rate of air (cc/cm²-day) through the bag was determined by measuring the difference in the weight of the bag when immersed in water before and after storage in the oven, over a given period of time.

Table 1 below provides the permeation rates of Bags #1-7 at various points during storage at 60° C., and Table 2 below provides the permeation rates of Bags #8-12 at various points during storage at 30° C.

TABLE 1
(Bags #1–7, Storage at 60° C.)

| | Days | Permeation | | | |
|---|---|---|---|---|---|
| | Stored | Rate | Permeation | Thickness | |
| Bag | at | of Methanol | Rate of Air | of Film | Structure |
| # | 60° C. | (g/cm²-day) | (cc/cm²-day) | (mil) | of Film |
| 1 | 7 | 1.4 × 10⁻³ | 7.37 × 10⁻³ | 3 | PE/Tie/PVDC/ |
| | | | | | Tie/PE |
| 2 | 18 | 1.7 × 10⁻³ | 10.1 × 10⁻³ | 2.4 | PET/PE/ |
| | | | | | EVOH/PE |
| 3 | 61 | 1.2 × 10⁻⁶ | 1.8 × 10⁻⁵ | 4.5 | PE/Al/PE/PE |
| 4 | 42 | 4 × 10⁻⁶ | <10⁻⁵ | 3 | PET/Al/PE |
| 5 | 18 | 6.3 × 10⁻⁶ | 2.3 × 10⁻⁴ | 3 | PP/PE/Al/PE |
| 6 | 3 | — | >3 × 10⁻³ | 1 | (Nylon 6)/ |
| | | | | | EVOH/ |
| | | | | | (Nylon 6) |
| 7 | 3 | — | >3 × 10⁻³ | 1 | (Nylon 6)/Al |

TABLE 2
(Bags #8–12, Storage at 30° C.)

| | Days | Permeation | | | |
|---|---|---|---|---|---|
| | Stored | Rate of | Permeation | Thickness | |
| Bag | at | Methanol | Rate of Air | of Film | Structure |
| # | 30° C. | (g/cm²-day) | (cc/cm²-day) | (mil) | of Film |
| 8 | 153 | 2.3 × 10⁻⁷ | 1.1 × 10⁻⁵ | 4.5 | PE/Al/PE/PE |
| 9 | 153 | 6.2 × 10⁻⁷ | 2.1 × 10⁻⁶ | 3 | PET/Al/PE |
| 10 | 72 | 2.6 × 10⁻⁷ | 1.2 × 10⁻⁵ | 3 | PP/PE/Al/PE |
| 11 | 38 | 3.6 × 10⁻⁴ | 5.7 × 10⁻⁴ | 3 | PE/Tie/PVDC/ |
| | | | | | Tie/PE |
| 12 | 38 | 4.9 × 10⁻⁴ | 1.6 × 10⁻³ | 2.4 | PET/PE/ |
| | | | | | EVOH/PE |

### Other Embodiments

While certain embodiments have been described, other embodiments are possible.

As an example, while certain housing materials have been described, in some embodiments, a cartridge housing can be formed of one or more other materials. In certain embodiments, a housing can be formed of a metal. For example, a housing can be formed of aluminum (e.g., aluminum foil) or copper (e.g., copper foil). A housing that is formed of aluminum or copper can be substantially impermeable to air. Examples of aluminum include Aluminum 1145, Aluminum 1130, and anodized aluminum. In some embodiments, a housing can be formed of stainless steel (e.g., stainless steel foil). A housing that is formed of stainless steel can be relatively stable in the presence of methanol. An example of stainless steel is 316 stainless steel. In certain embodiments (e.g., in a fuel cell system including additive-free methanol), a cartridge can have a housing including 304 stainless steel, 316 stainless steel, 316L stainless steel, or brass. In some embodiments of a fuel cell system using a gel-based fuel and/or including one or more ionic fuel additives, a stainless steel housing can be relatively unlikely to react with the fuel (e.g., with the additives in the fuel). Ionic fuel additives are described, for example, in Bofinger et al., U.S. patent application Ser. No. 11/137,848, filed on May 25, 2005, and entitled “Fuel Cells”. While aluminum and copper have been described, in certain embodiments, a housing can be formed of another metal, such as nickel, gold, or platinum. A housing can be formed of a single metal layer, or can be formed of multiple metal layers.

In some embodiments, a housing can be formed of nylon (e.g., Nylon 6/6), polyester, polycarbonate, polyvinylidene chloride (PVDC), polyethylene-co-polyvinyl alcohol (EVOH), polyethylene (PE), polypropylene (PP), high density polyethylene (HDPE), low density polyethylene (LDPE), ultra high molecular weight polyethylene (UHMWPE), polyphenyleneoxide (e.g., NORYL® resin, from GE Plastics), or acetal homopolymer (e.g., Delrin®, from DuPont).

Other examples of materials that can be used to form a cartridge housing include elastomers, such as ethylene propylene rubber (EPDM) and Neoprene polychloroprene (from DuPont). Further examples of housing materials include copolymers, such as cyclic olefin copolymers (e.g., Ticona Topas® COC, from Ticona), which can, for example, be substantially impermeable to methanol.

An additional example of a material that can be used in a fuel cartridge housing is an ozonated polymer. In some embodiments, ozonation of a polymer can decontaminate the surface of the polymer. For example, in certain embodiments, ozonation of a polymer can remove residual organic materials (e.g., from polymer processing) from the surface of the polymer. The removal of the residual organic materials can, for example, result in enhanced fuel cell performance in a fuel cell system including the fuel cartridge housing.

As another example, in some embodiments, a cartridge housing can be formed by plasma-treating a polymer with oxygen and/or one or more other ionizable gases (e.g., argon (Ar), nitrogen (N₂), methane (CH₄), helium (He), hydrogen (H₂)). In certain embodiments, after the polymer has been plasma-treated, functional groups can be grafted to the surface of the polymer. For example, in some embodiments, a plasma-treated polymer can be exposed to a fluorinated gas species (e.g., CF₄) which can modify the surface of the polymer. Plasma treatment of a polymer and/or grafting of functional groups to the surface of a polymer can, for example, reduce the permeability of the polymer to methanol, decontaminate the polymer, and/or enhance the chemical stability of the polymer.

As a further example, while housings formed by sealing two sheets of material together have been described, in some embodiments, a housing (e.g., an inner housing) can be formed in one or more other ways. For example, in certain embodiments, a housing can be formed by shaping one sheet of material into the desired shape of the housing. In some embodiments, one sheet of material can be folded and its edges can be sealed to each other to form a housing. In certain embodiments, a housing can be formed out of more than two (e.g., three, four, five) sheets of material. In some embodiments, a housing may not be formed of any sheets of material. In certain embodiments, a housing can be formed using a molding process.

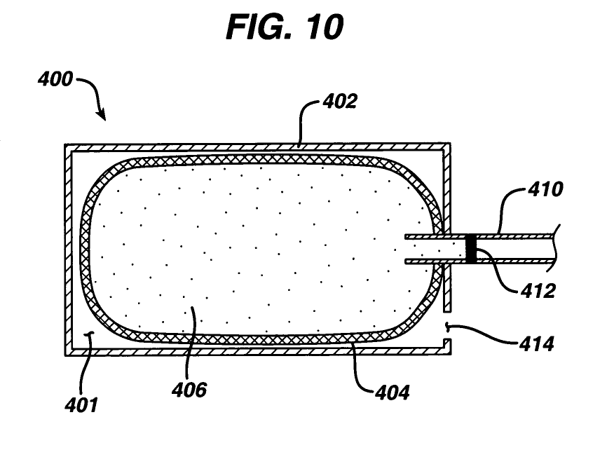

As an additional example, in certain embodiments, a fuel source can include at least one pump and/or can be attached to at least one pump. For example, FIG. 10 shows a cartridge 400 including an outer housing 402 and an inner housing 404 within outer housing 402. Inner housing 404 contains a fuel 406 (e.g., methanol). A fuel inlet 410 extends through both outer housing 402 and inner housing 404, and is in fluid communication with fuel 406. A pump 412 is disposed within fuel inlet 410, and can be used to pump fuel 406 out of inner housing 404. Pump 412 can help to regulate the flow of fuel 406 out of inner housing 404 (e.g., providing fuel 406 to an anode of a fuel cell at a controlled rate). Cartridge 400 also includes a membrane vent 414 that vents out to the atmosphere. Membrane vent 414 can, for example, limit the likelihood of a vacuum forming in the space 401 between inner housing 404 and outer housing 402.

As another example, while inner housings have been described, in some embodiments, other components of a fuel cell system and/or a fuel cartridge, such as an outer housing of a fuel cartridge, can include (e.g., can be formed of) one or more of the above-described materials.

As a further example, while direct methanol fuel cell systems have been described, in some embodiments, one or more of the above-described fuel sources and/or housings can be used in a reformer, and/or in a different type of fuel cell system (e.g., in a different type of direct oxidation fuel cell system). As an example, one or more of the above-described fuel sources and/or housings can be used in a hydrogen fuel cell system, such as a hydrogen polymer electrolyte membrane (PEM) fuel cell system. Hydrogen fuel cells are described, for example, in Davis et al., U.S. Patent Application Publication No. US 2004/0229090, published on Nov. 18, 2004, and in Davis et al., U.S. Patent Application Publication No. US 2004/0229101, published on Nov. 18, 2004.

As an additional example, in some embodiments, a fuel source and/or one or more other components of a fuel cell system can include one or more colorants. In certain embodiments, the colorants can be in the form of a coating on at least a portion of the fuel source (e.g., on an interior surface of an outer housing of a fuel source). The colorant coating can, for example, provide an indication of a fuel leak from the fuel source (e.g., from an inner housing of the fuel source). In some embodiments, the colorant can be mixed with the fuel. A colorant that is mixed with the fuel can, for example, remain in the fuel source as the fuel is delivered to a fuel cell (e.g., by being passed through a membrane that is impermeable to the colorant). An increase in the concentration of the colorant in the fuel source can provide an indication that fuel has been delivered from the fuel source, and/or can provide an indication of the amount of fuel remaining in the fuel source. Fuel cell systems including colorants are described, for example, in Bofinger et al, U.S. patent application Ser. No. 11/137,848, filed on May 25, 2005, and entitled “Fuel Cells”.

All references, such as patent applications, publications, and patents, referred to herein are incorporated by reference in their entirety.

Other embodiments are in the claims.

What is claimed is:

1. A cartridge, comprising:
a first housing comprising:
a first layer comprising a first polymer; and
a second layer comprising a first metal,
wherein the first housing contains an alcohol fuel or a hydrocarbon fuel.

2. The cartridge of claim 1, further comprising a second housing.

3. The cartridge of claim 2, wherein the first housing is disposed within the second housing.

4. The cartridge of claim 3, wherein the second housing includes a membrane vent.

5. The cartridge of claim 1, wherein the first housing contains an alcohol fuel.

6. The cartridge of claim 5, wherein the alcohol fuel comprises methanol.

7. The cartridge of claim 1, wherein the first housing has a thickness of at most 0.005 inch.

8. The cartridge of claim 1, wherein the first metal comprises aluminum.

9. The cartridge of claim 1, wherein the first layer and the second layer are coextensive.

10. The cartridge of claim 1, wherein the first polymer has a methanol permeability coefficient of at most about 1.6×10⁻⁴ μg-cm/cm²-s.

11. The cartridge of claim 1, wherein the first polymer has an oxygen permeability coefficient of at most about 5×10⁻⁵ cm³ (STP)-cm/cm²-s-Pa.

12. The cartridge of claim 1, wherein the first polymer is selected from the group consisting of polyethylene, polypropylene, and combinations thereof.

13. The cartridge of claim 1, wherein the first housing further comprises a third layer.

14. The cartridge of claim 13, wherein the third layer comprises a second polymer.

15. The cartridge of claim 13, wherein the third layer comprises a second metal.

16. A cartridge, comprising:
a first housing comprising a metallized polymer, a halogenated polymer, or a combination thereof,
wherein the first housing contains an alcohol fuel or a hydrocarbon fuel.

17. The cartridge of claim 16, wherein the polymer has a methanol permeability coefficient of at most about 1.6×10⁻⁴ μg-cm/cm²-S.

18. The cartridge of claim 16, wherein the polymer has an oxygen permeability coefficient of at most about 5×10⁻¹⁵ cm³(STP)-cm/cm²-s-Pa.

19. The cartridge of claim 16, wherein the first housing comprises a metallized polymer.

20. The cartridge of claim 16, wherein the first housing comprises a halogenated polymer.

21. A cartridge, comprising:
a first housing comprising a first polymer layer and a second polymer layer that contacts the first polymer layer,
wherein the first housing contains an alcohol fuel or a hydrocarbon fuel.

22. The cartridge of claim 21, wherein the first polymer layer has a methanol permeability coefficient of at most about 1.6×10⁻⁴ μg-cm/cm²-S.

23. The cartridge of claim 21, wherein the first polymer layer has an oxygen permeability coefficient of at most about 5×10⁻⁵ cm³(STP)-cm/cm²-s-Pa.

24. The cartridge of claim 21, wherein the first polymer layer comprises polyvinylidene dichloride, ethylene vinyl alcohol polymer, polyvinylidene difluoride, or a combination thereof.

25. The cartridge of claim 24, wherein the second polymer layer comprises polyethylene, polypropylene, or a combination thereof.

26. The cartridge of claim 21, further comprising a third polymer layer.

27. A cartridge, comprising:
a first housing comprising a polymer and a glass, a ceramic, carbon, or a combination thereof,
wherein the first housing contains an alcohol fuel or a hydrocarbon fuel.

28. The cartridge of claim 27, wherein the polymer has a methanol permeability coefficient of at most about 1.6×10⁻⁴ μg-cm/cm²-S.

29. The cartridge of claim 27, wherein the polymer has an oxygen permeability coefficient of at most about 5×10⁻¹⁵ cm³(STP)-cm/cm²-s-Pa.

30. The cartridge of claim 27, wherein the first housing comprises a glass.

31. The cartridge of claim 27, wherein the first housing comprises a ceramic.

32. The cartridge of claim 27, wherein the first housing comprises carbon.
